(19) United States
(12) Patent Application Publication
(10) Pub. No.: US 2016/0305618 A1
(43) Pub. Date: Oct. 20, 2016

(54) LUMINAIRE

(71) Applicant: Hubbell Incorporated, Shelton, CT (US)

(72) Inventors: Eric S. Miller, Simpsonville, SC (US); Raymond A. Brown, US, SC (US); Cleveland Blankenship, Fountain Innn, SC (US); Jeff Spitzer, Taylors, SC (US); Seng Vang, Piedmont, SC (US)

(21) Appl. No.: 15/131,975

(22) Filed: Apr. 18, 2016

Related U.S. Application Data
(60) Provisional application No. 62/149,291, filed on Apr. 17, 2015.
(60) Provisional application No. 62/155,294, filed on Apr. 30, 2015.
(60) Provisional application No. 62/300,418, filed on Feb. 26, 2016.

(51) Int. Cl. F21K 99/00; F21V 23/00; F21V 23/04; F21V 5/00

(52) U.S. Cl. CPC F21K 9/175; F21V 5/00; F21V 23/003; F21V 23/0471; F21Y 2103/003

(57) ABSTRACT

A luminaire includes a support member and a light assembly. The support member includes a first end and a second end, and defines a longitudinal axis extending therebetween. The support member defines a center portion extending along the longitudinal axis. The light assembly includes at least one board supporting at least one light emitting element. The board is coupled to the center portion of the support member and oriented parallel to the longitudinal axis.

### CROSS-REFERENCE TO RELATED APPLICATIONS

This application claims the benefit of co-pending, prior-filed U.S. Provisional Patent Application No. 62/149,291, filed Apr. 17, 2015, U.S. Provisional Patent Application No. 62/155,294, filed Apr. 30, 2015, and U.S. Provisional Patent Application No. 62/300,418, filed Feb. 26, 2016. The entire contents of each of these documents are incorporated by referenced hereing.

### BACKGROUND

The present application relates generally to light fixtures, and particularly to a luminaire including light-emitting diodes (LEDs).

Conventional lighting fixtures include a reflector and a board supporting a number of LEDs. The board is in electrical communication with a power source and a programmable driver for controlling the output of the LEDs.

### SUMMARY

In one aspect, a luminaire includes a support member and a light assembly. The support member includes a first end and a second end and defines a longitudinal axis extending therebetween. The support member includes a center portion extending along the longitudinal axis and a pair of flanges. Each flange is formed on one side of the center portion and extends along the center portion in a direction parallel to the longitudinal axis. The flanges and the center portion are substantially planar. The light assembly includes at least one board supporting at least one light emitting element. The at least one board is coupled to the center portion of the support member and oriented parallel to the longitudinal axis.

In another aspect, a luminaire includes a support member and a light assembly. The support member includes a first end and a second end and defines a longitudinal axis extending therebetween. The support member further includes a channel and at least one flange coupled to the channel. The channel and the at least one flange extend along the longitudinal axis. The light assembly includes at least one circuit board supporting at least one light emitting diode. The light board is coupled to one surface of the support member and positioned within the channel, and the light board is oriented parallel to the longitudinal axis.

In one aspect, a lens for a light-emitting element includes at least one elongated board supporting at least one light-emitting diode. The board defines a first end, a second end, and a board axis extending therebetween. The lens includes a refractor portion and a pair of side portions. The refractor portion includes an inner surface and an outer surface. The inner surface is positioned proximate the light-emitting element, and the inner surface is oriented at an angle such that the light generated by the light-emitting element exhibits total internal reflection within the lens. The side portions are positioned on each side of the refractor portion and extend along a side of the light-emitting element.

Other aspects will become apparent by consideration of the detailed description and accompanying drawings.

### BRIEF DESCRIPTION OF THE DRAWINGS

FIG. 1 is a lower perspective view of a luminaire.

FIG. 2 is an upper perspective view of the luminaire of FIG. 1.

FIG. 3 is an enlarged upper perspective view of the luminaire of FIG. 1.

FIG. 4A is an end view of the luminaire of FIG. 1.

FIG. 4B is an end view of a luminaire according to another embodiment.

FIG. 4C is an end view of a luminaire according to another embodiment.

FIG. 4D is an end view of a luminaire according to another embodiment.

FIG. 4E is an end view of a luminaire according to another embodiment.

FIG. 5 is an enlarged lower perspective view of the luminaire of FIG. 1.

FIG. 6 is an end view of the luminaire of FIG. 1 with an end cover removed.

FIG. 7 is a lower perspective view of a luminaire according to another embodiment.

FIG. 8 is an upper perspective view of the luminaire of FIG. 7.

FIG. 9 is a top view of the luminaire of FIG. 7.

FIG. 10 is a side view of the luminaire of FIG. 7

FIG. 11 is a bottom view of the luminaire of FIG. 7.

FIG. 12A is an end view of the luminaire of FIG. 7.

FIG. 12B is a top view of a lens.

FIG. 12C is an end view of the lens of FIG. 12B.

FIG. 13 is a lower perspective view of a luminaire according to another embodiment.

FIG. 14 is an upper perspective view of the luminaire of FIG. 13.

FIG. 15 is a lower perspective view of a luminaire according to another embodiment, with some refractors removed.

FIG. 16 is an upper perspective view of the luminaire of FIG. 15.

FIG. 17 is a lower perspective view of a luminaire according to another embodiment, with some refractors removed.

FIG. 18 is an upper perspective view of the luminaire of FIG. 17.

FIG. 19 is an end view of the luminaire of FIG. 17.

FIG. 20 is an upper perspective view of a luminaire according to another embodiment.

FIG. 21 is a lower perspective view of the luminaire of FIG. 20.

FIG. 22 is a bottom view of the luminaire of FIG. 20.

### DETAILED DESCRIPTION

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

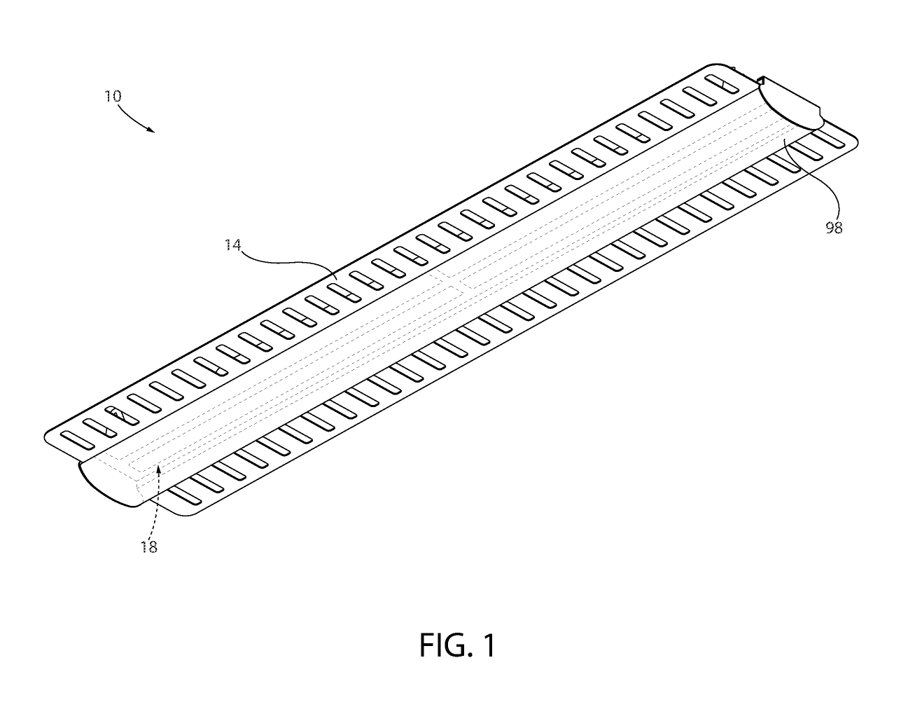

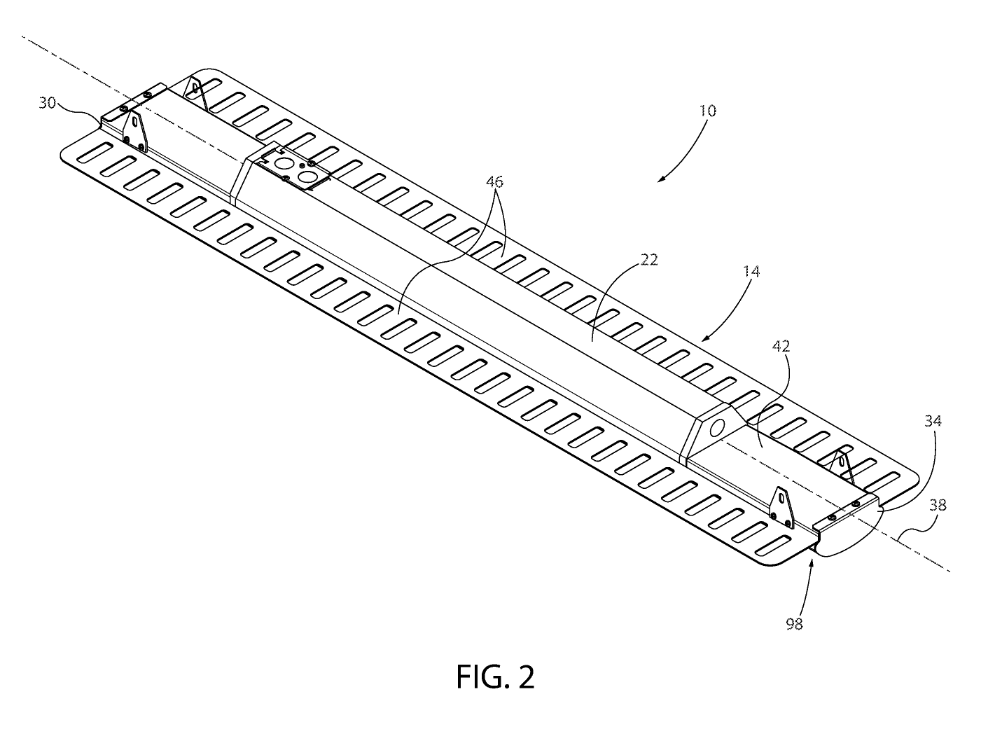

FIGS. 1 and 2 illustrate a light fixture or luminaire 10. In one embodiment, the luminaire 10 is used in a commercial or industrial environment. The luminaire 10 includes a support member 14, at least one light emitter component 18 coupled to the support member 14, and an enclosure 22 (FIG. 2) coupled to the support member 14. In the illustrated embodiment, the luminaire 10 also includes a diffuser 98 covering the light emitter component 18. In some embodiments, the support member 14 is secured to a ceiling (not shown).

Referring to FIG. 2, in the illustrated embodiment, the support member 14 is formed as an elongated plate having a first end 30 and a second end 34, and defining a longitudinal axis 38 extending therebetween. The plate includes a channel 42 extending along the longitudinal axis 38, and a pair of peripheral portions or flanges 46 extending along either side of the channel 42. In the illustrated embodiment, the channel 42 is offset from the flanges 46 such that the channel 42 is positioned above each flange 46 and defines a recess positioned between the flanges 46. In the illustrated embodiment, the light emitter component 18 is coupled to a lower surface of the channel 42 and positioned in the recess.

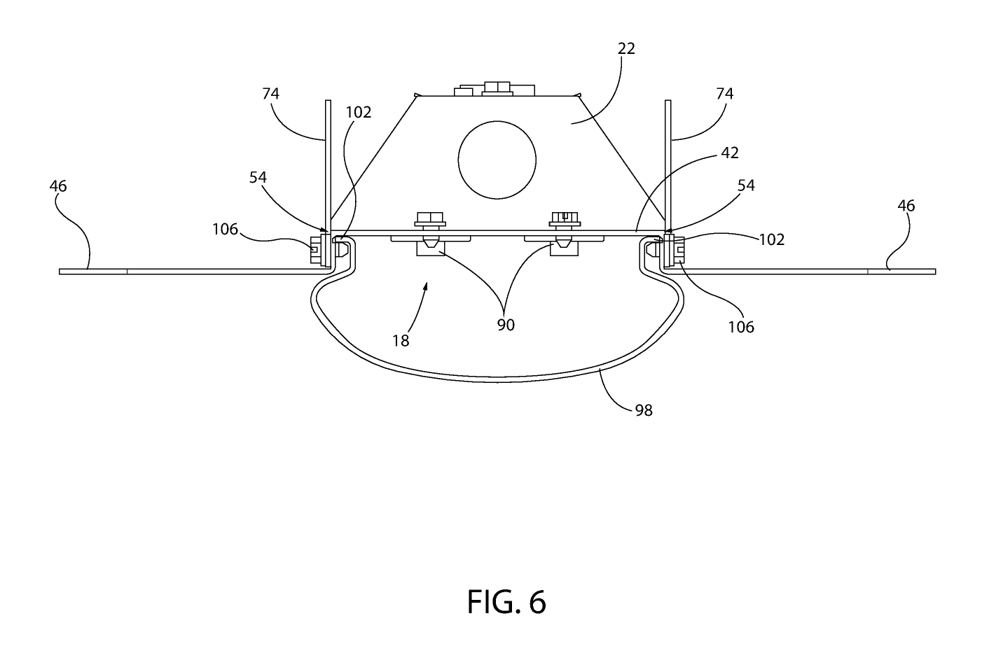

In one embodiment, as best shown in FIG. 6, the channel 42 is formed by a jog bend 54 between a center portion of the plate 14 and each flange 46. The channel may have a “hat-shaped” cross-section. Each jog bend 54 is formed by a pair of bends formed on opposite surfaces of the plate and offset by an offset distance 62. In one embodiment, each bend forms a 90 degree angle. The length of the offset distance 62 defines the height of the channel 42. The jog bend 54 increases the rigidity of the plate. In one embodiment, the offset distance 62 (i.e., the height of the channel 42) is about 0.4375 inches, the width of the channel 42 (i.e., a dimension measured transverse to the axis 38 and parallel to the plane of the channel 42) is about 3.8125 inches, and the width of the support member 14 is about 10 inches.

In some embodiments, the offset distance 62 is between approximately 0.375 inches and approximately 0.500 inches. In some embodiments, the offset distance 62 is between approximately 0.4062 inches and approximately 0.4688 inches. In some embodiments, the offset distance 62 is approximately 0.4375 inches.

In some embodiments, the width of the channel 42 is between approximately 3.625 inches and approximately 4 inches. In some embodiments, the width of the channel 42 is between approximately 3.7812 inches and approximately 3.8438 inches. In some embodiments, the width of the channel 42 is approximately 3.8125 inches.

In some embodiments, the ratio of the height of the channel 42 to the width of the channel 42 is between approximately 9.3% and approximately 13.8%. In some embodiments, the ratio of the height of the channel 42 to the width of the channel 42 is between approximately 10.5% and approximately 12.4%. In some embodiments, the ratio of the height of the channel 42 to the width of the channel 42 is approximately 11.5%.

In some embodiments, the ratio of the height of the channel 42 to the overall width of the support member 14 is between approximately 3.7% and approximately 5%. In some embodiments, the ratio of the height of the channel 42 to the overall width of the support member 14 is about 4.4%. In some embodiments, the ratio of the width of the channel 42 to the overall width of the support member 14 is between about 36.2% and about 40%. In some embodiments, the ratio of the width of the channel 42 to the overall width of the support member 14 is about 38.1%.

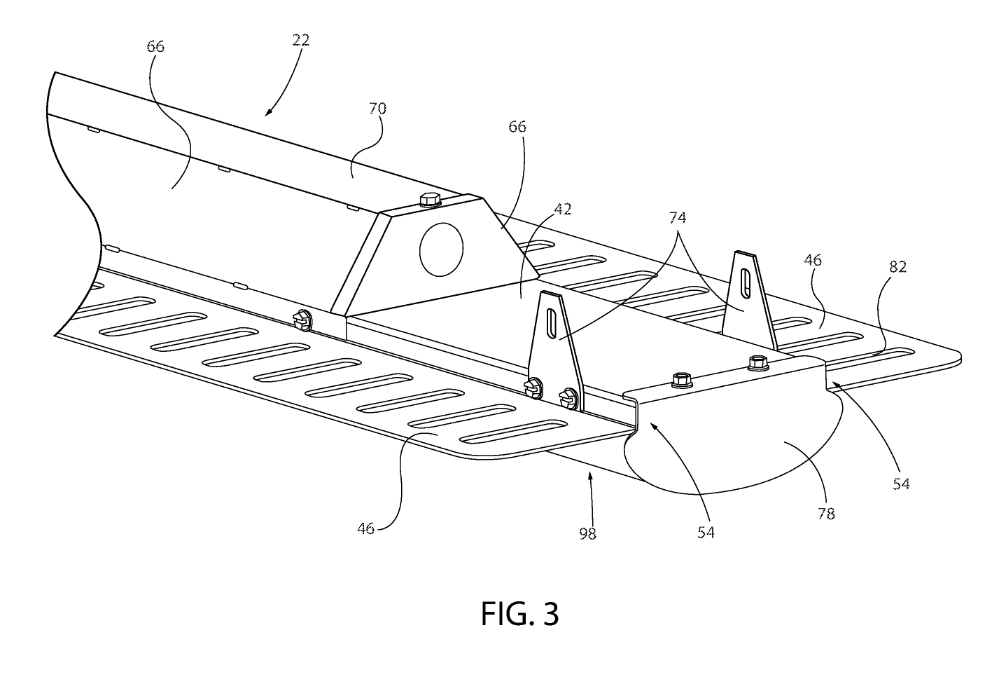

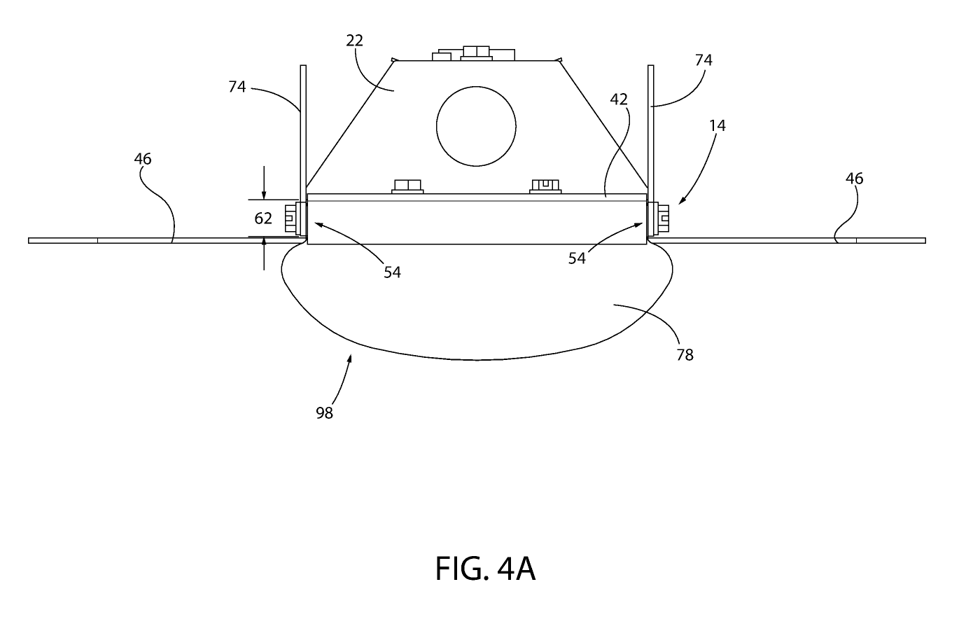

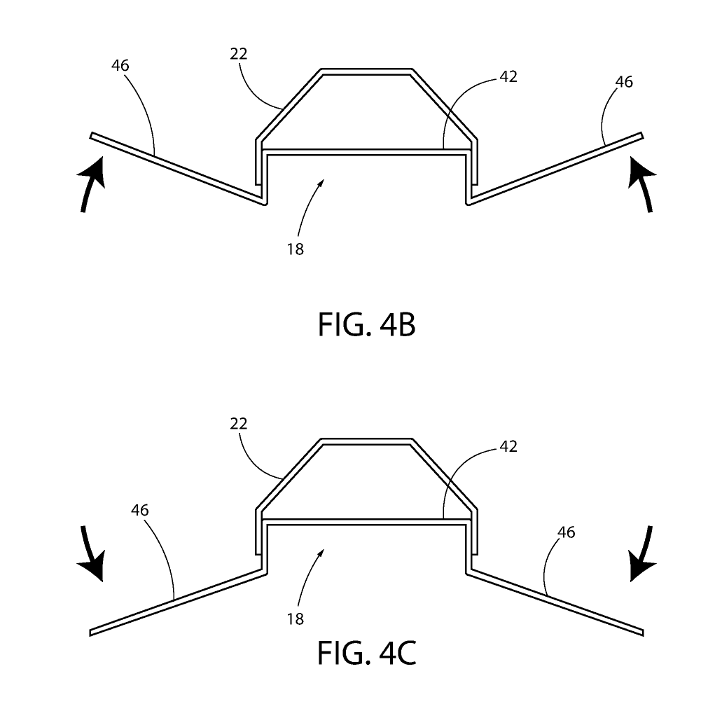

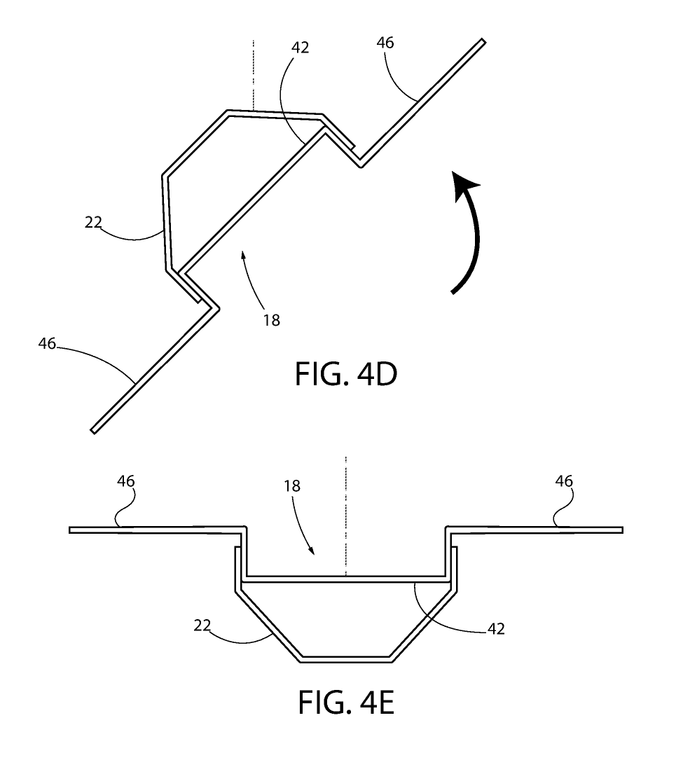

Referring to FIGS. 3 and 4A, the enclosure 22 is coupled to a surface of the channel 42 opposite the light emitter component 18 (i.e., an upper surface of the channel 42). The enclosure 22 extends along at least a portion of the channel 42 parallel to the axis 38 (FIG. 2), and the lower extent of each side of the enclosure 22 is coupled to a vertical portion of the channel 42 formed by the jog bend 54. In the illustrated embodiment, the enclosure 22 has a cross-section defining a trapezoidal shape. That is, the enclosure 22 has longitudinal surfaces 66 that are inclined or angled relative to a flat upper surface 70. In the illustrated embodiment, the surfaces 66 form an acute angle relative to the surface of the channel 42 and relative to the upper surface 70 of the enclosure 22.

As best shown in FIG. 3, the luminaire 10 may include support brackets 74 coupled to each side of a vertical portion of the channel 42. The support brackets 74 extend upwardly and are coupled to a ceiling or other structure (not shown). In one embodiment, each bracket 74 engages a hook connected to a cable or chain to suspend the luminaire 10 from the ceiling. In other embodiments, the luminaire 10 may not include the brackets 74 and/or may include a different mechanism for supporting the luminaire 10. The luminaire 10 further includes end covers 78, and each end cover 78 is coupled to an end of the channel 42 to enclose the ends of the channel 42. In some embodiments, the end covers 78 are formed from steel. In other embodiments, the end covers 78 may be formed from a plastic or polymeric material, such as a plastic made from an injection-molding process.

In addition, each flange 46 may include slots 82. The slots 82 may have an elongated (e.g., rectangular or elliptical) shape extending in a direction generally perpendicular to the longitudinal axis 38 (FIG. 2), or the slots 82 may have a different shape (e.g., square, circular). In other embodiments, the slots 82 may extend in another direction that is not perpendicular to the axis 38.

As shown in FIG. 4A, the luminaire 10 is coupled to a structure such that the light emitter component 18 faces downwardly to provide direct lighting below the luminaire 10. In other embodiments, the luminaire 10 may be oriented such that the light emitter component 18 faces upwardly (FIG. 4E) to provide indirect lighting in the vicinity of the luminaire 10. In still other embodiments, the luminaire 10 may be oriented at an angle (FIG. 4D) so that the light emitter component 18 is directed at an angle between vertically up and vertically down.

Further, in the illustrated embodiment the flanges 46 are oriented in the same plane as one another, and are parallel to the channel 42. In other embodiments, the flanges 46 may be oriented to form an acute angle relative to the channel 42 so that the flanges 46 are positioned closer to the enclosure 22 (FIG. 4B). Alternatively, the flanges 46 can be angled and positioned closer to the light emitter component 18 (FIG. 4C). In addition, each of the flanges 46 may be formed at different angles relative to one another.

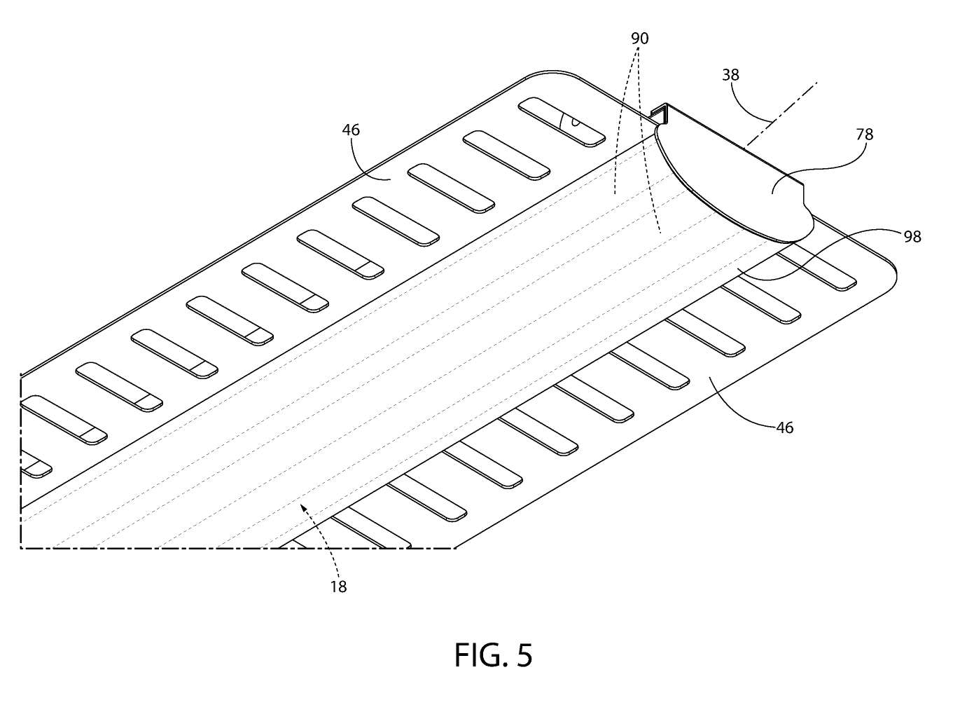

Referring now to FIGS. 5 and 6, the light emitter component 18 may include multiple light emitting elements coupled to a printed circuit board (PCB). In the illustrated embodiment, the light emitter component 18 is recessed relative to each flange 46 and includes multiple light emitting diode (LED) boards 90. Each LED board 90 includes multiple LEDs supported on an elongated circuit board (e.g., a printed circuit board or PCB), and the LED boards 90 are oriented parallel to the longitudinal axis 38 (FIG. 5).

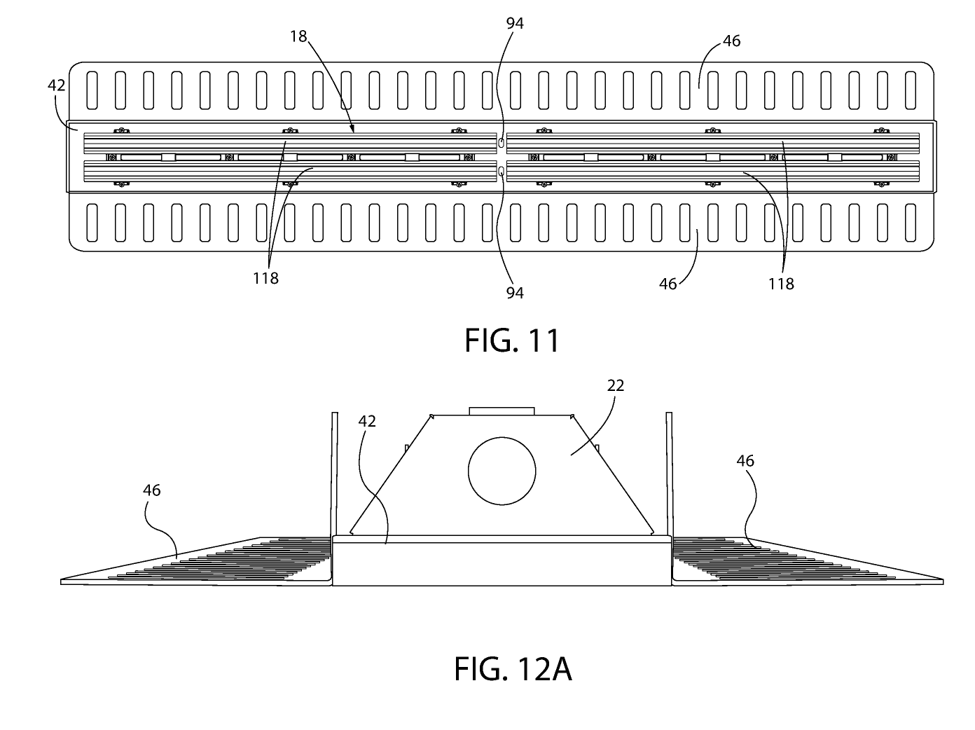

In the illustrated embodiment, the light emitter component 18 includes two sets of two LED boards 90 (four boards total). Each set includes a pair of parallel LED boards 90, and the sets are arranged in an end-to-end configuration. In one embodiment, the adjacent ends of the LED boards 90 are positioned adjacent one another but spaced apart from each other. Each LED board 90 is powered by a control assembly (not shown) housed in the enclosure 22 and including one or more drivers. The LED board 90 is in electrical communication with the control assembly via wires (not shown). The wires extend through openings 94 (FIG. 11) in the channel 42 between the ends of the LED boards 90 and the wires pass into the enclosure 22. In other embodiments, the light emitter component 18 may include fewer or more LED boards 90, and the LED boards 90 may be arranged in a different manner.

In the illustrated embodiment, the luminaire includes an optic or lens, such as the diffuser 98, secured to the support member 14 and extending over the LED boards 90. As best shown in FIG. 6, the diffuser 98 may be an acrylic diffuser having a cross-section defining an elliptical or semi-elliptical shape. The diffuser 98 may have two ends 102, each of which is received within the channel 42. Each end 102 may be positioned between the channel and screws 106 inserted in the vertical portion of the jog bend 54 to retain the diffuser 98. In some embodiments, the screws 106 may also secure the support brackets 74 to the channel 42. The diffuser 98 can be installed and uninstalled without requiring separate tools. The diffuser 98 extends around three sides of each LED board 90, covering at least a 120 degree spread of light emitted from the LED boards 90. The diffuser 98 provides, among other things, a wider light distribution compared to most refractors 118 and/or provides a desired aesthetic.

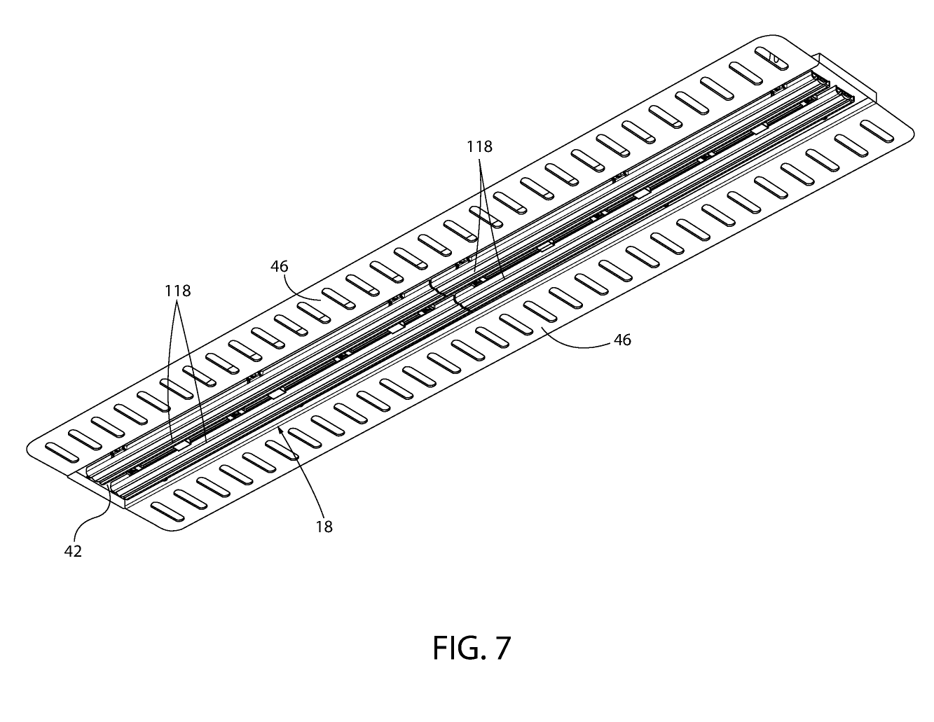

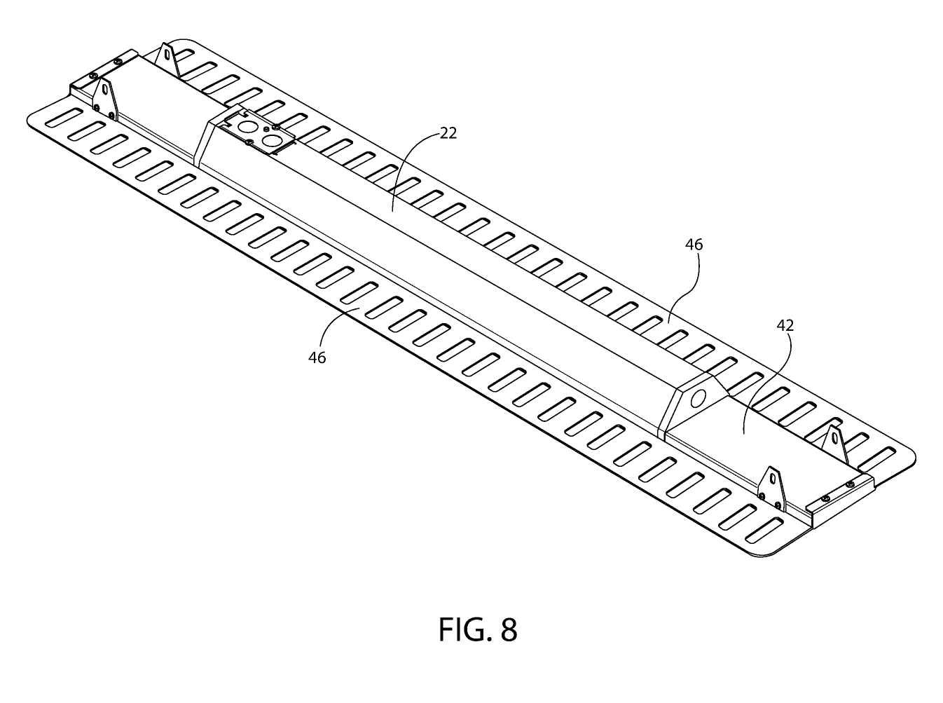

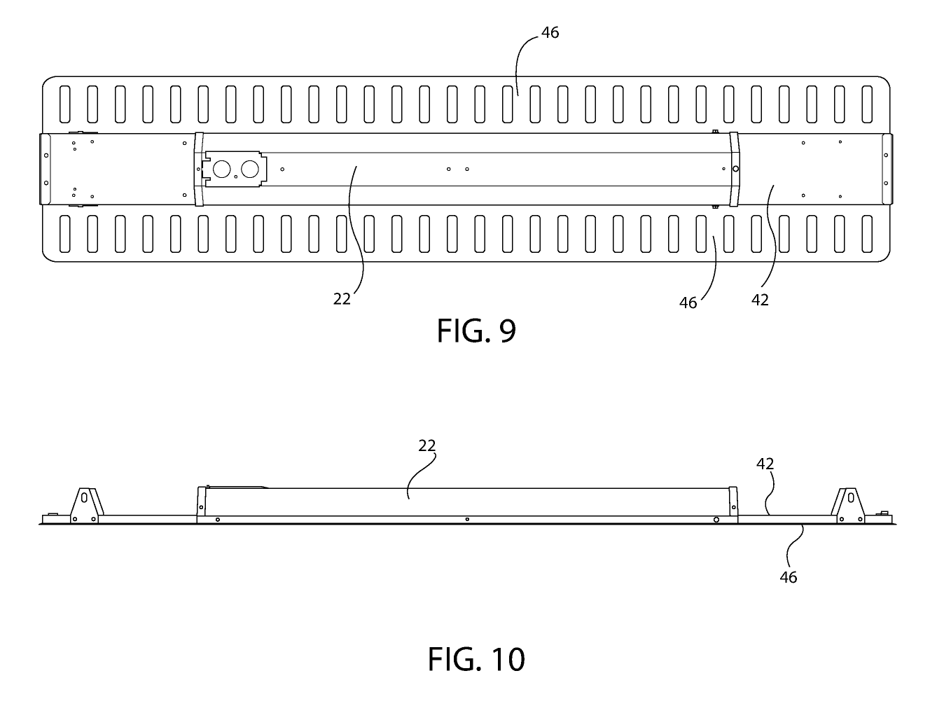

In another embodiment, shown in FIGS. 7-12C, the luminaire 10 may include a refractor 118 instead of (or in addition to) a diffuser. In the illustrated embodiment, a separate refractor 118 extends over each LED board 90. Each refractor 118 is individually secured to the support member 14. Each refractor 118 may be an injection molded acrylic refractor encasing each LED board 90, and each refractor 118 may be secured to the channel 42 by fasteners (e.g., screws). In some embodiments, the refractors 118 have a low profile such that the refractors 118 are shorter than the offset distance 62 (FIG. 5) of the channel 42 and do not extend beyond an edge of the channel 42.

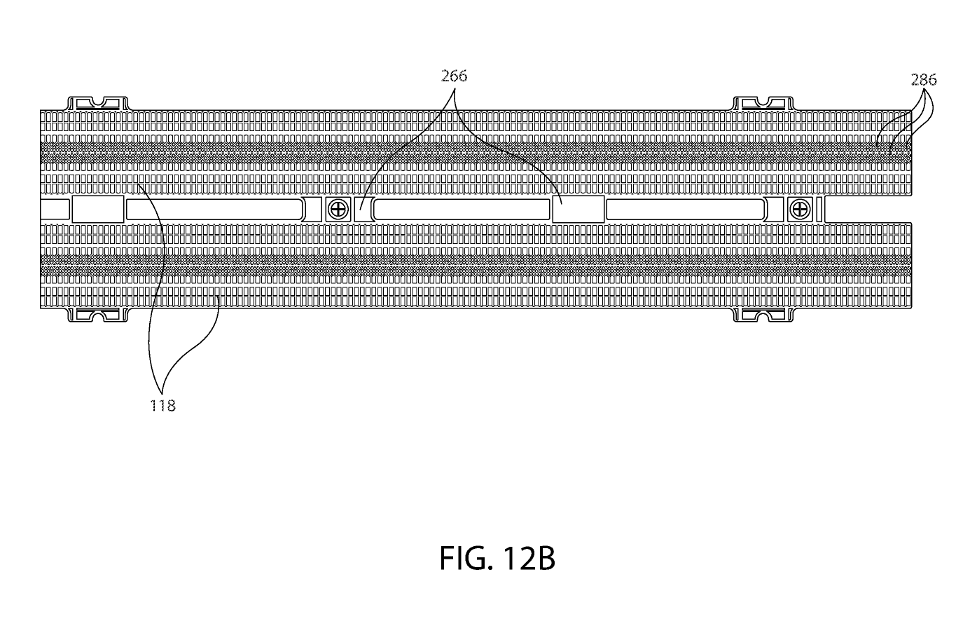

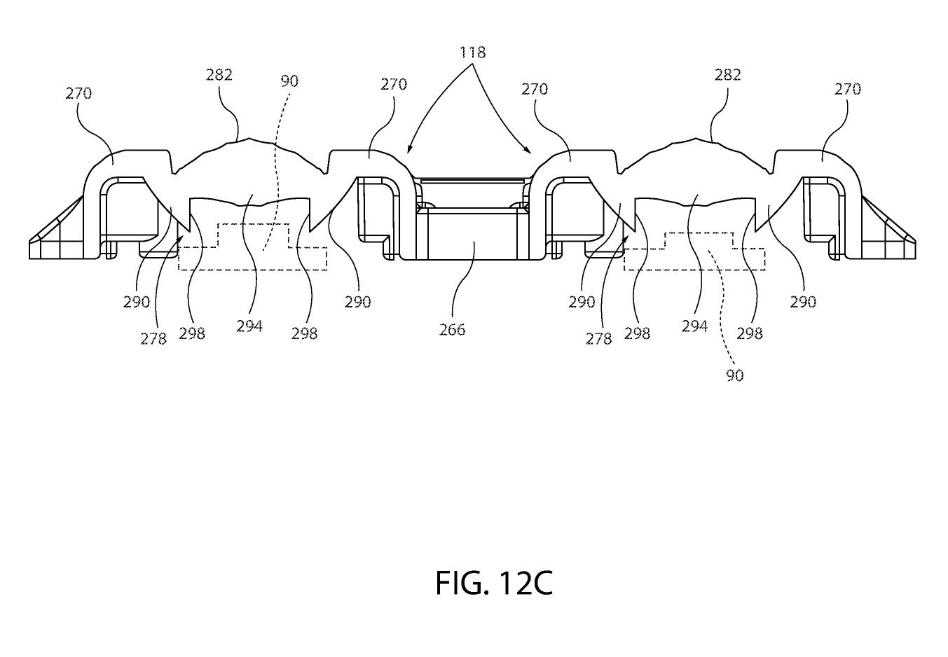

As shown in FIG. 12B, each refractor 118 may be coupled to one another by connecting portions 266 (FIG. 12B) extending laterally between the refractors 118, and the refractors 118 may be formed integrally with one another. In one embodiment, two of the refractors 118 are formed integrally with one another. In other embodiments, fewer or more refractors 118 may be formed together. Forming the refractors 118 integrally with one another reduces the number of connection points and fasteners that must be used to couple the refractor 118 to the support member 14. In the illustrated embodiment, an outer surface of the refractor 118 has diamond shaped formations 286.

As shown in FIG. 12C, each refractor 118 includes a pair of side portions 270 extending parallel to one another, and a bridge or refractor portion extending between the side portions 270. In some embodiments, the side portions 270 curve through an angle of approximately 290 degrees. The refractor portion has an inner surface 278 positioned proximate the LEDs and an outer surface 282 facing opposite the inner surface 278. In the illustrated embodiment, the outer surface 282 has a convex shape extending outwardly or protruding with respect to the LED board 90. The outer surface 282 has sides that are recessed below the side portions 270, but the apex of the outer surface 282 extends above the side portions 270.

In the illustrated embodiment, the inner surface 278 includes a pair of transition portions 290 and a center portion 294 extending between the transition portions 290. The transition portions 290 have a curved, convex shape that protrudes toward the LED board 90. The center portion 294 forms a slot or recess between the transition portions 290 to accommodate the LEDs. The slot is formed by the center portion 294 and walls 298 that are generally perpendicular relative to the plane of the support member 14. The junction between the transition portion 290 and each wall 298 forms an edge. In one embodiment, the center portion 294 has a slight curvature extending inwardly toward the LED board 90.

The structure of the refractor 118 causes the light emitted by each LED to be totally internally reflected (TIR) from the inner surface 278 until it reaches the outer surface 282. The light leaves the outer surface 282 along a linear path parallel to the longitudinal axis 38. The refractor 118 focuses the light output by the LED board 90 such that the light is distributed along a linear path (also known as linear aisle lighting or “LAL”) without the need for a reflector. In one embodiment, each refractor 118 directs light output from the LEDs toward a vertical surface of a retail shelf (not shown) to provide a desired illuminance or light intensity while requiring a lower power consumption than conventional light fixtures. In one embodiment, the LED board 90 is powered by a power source providing 90-110 watts, and the LED board 90 and refractor 118 provide 25 foot-candles at a vertical height of 14 feet. Each refractor may be optically clear and stabilized with respect to ultraviolet (UV) light, and each refractor may have a refractive index of approximately 1.49.

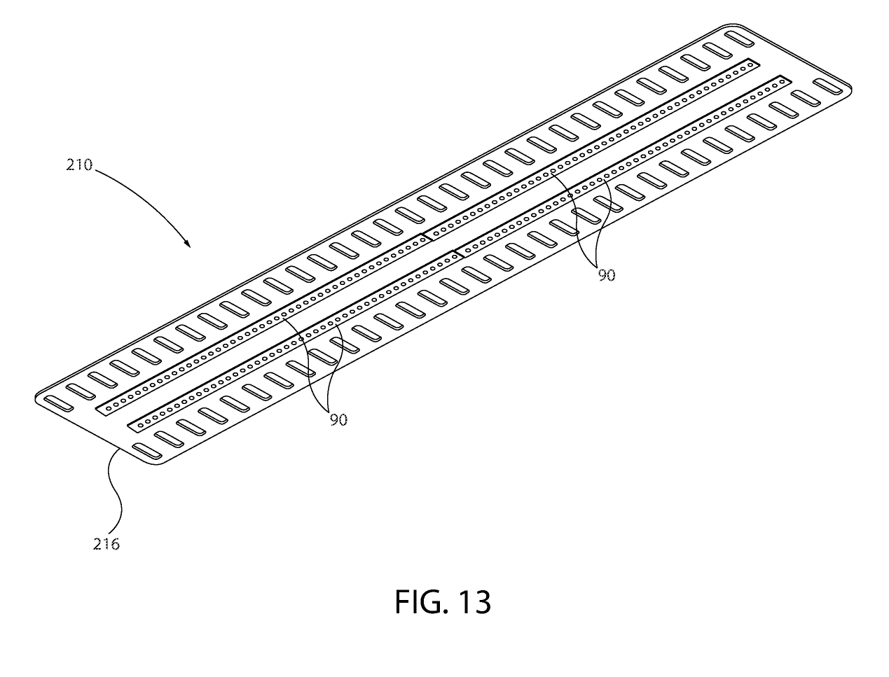

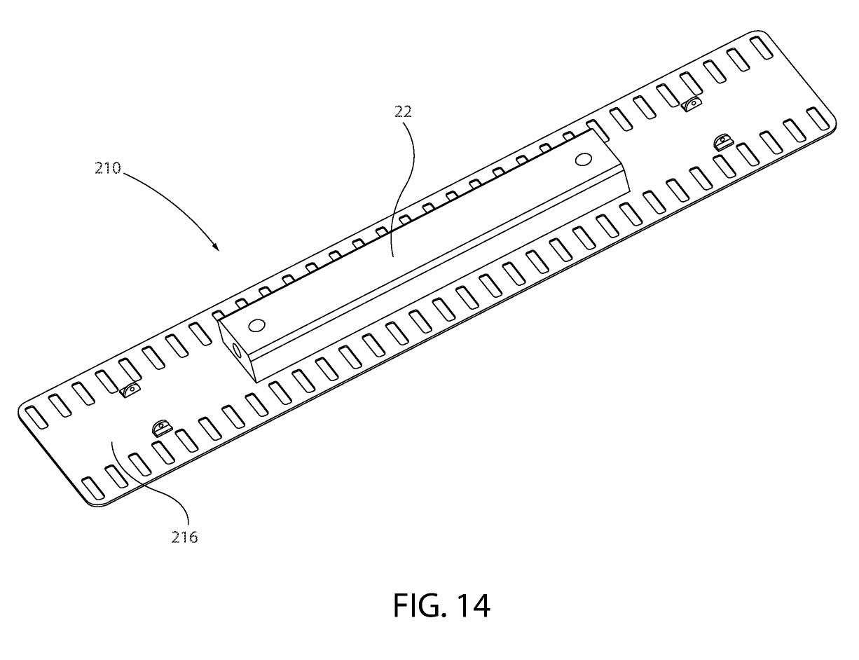

FIGS. 13 and 14 illustrate another embodiment of the luminaire 210 in which the support member is formed as a flat plate 216 without a channel. The light emitter component 18 may include multiple LED boards 90 supported on a surface of the plate 216 with or without a lens or optic covering the light emitter component 18. That is, in one embodiment, the luminaire 10 does not include a diffuser 98 or a refractor 118.

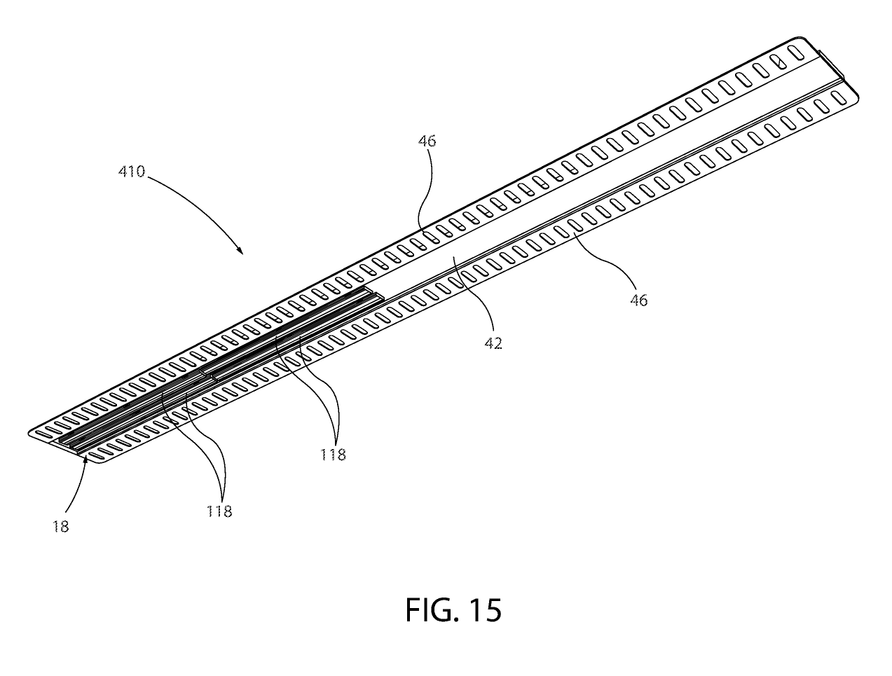

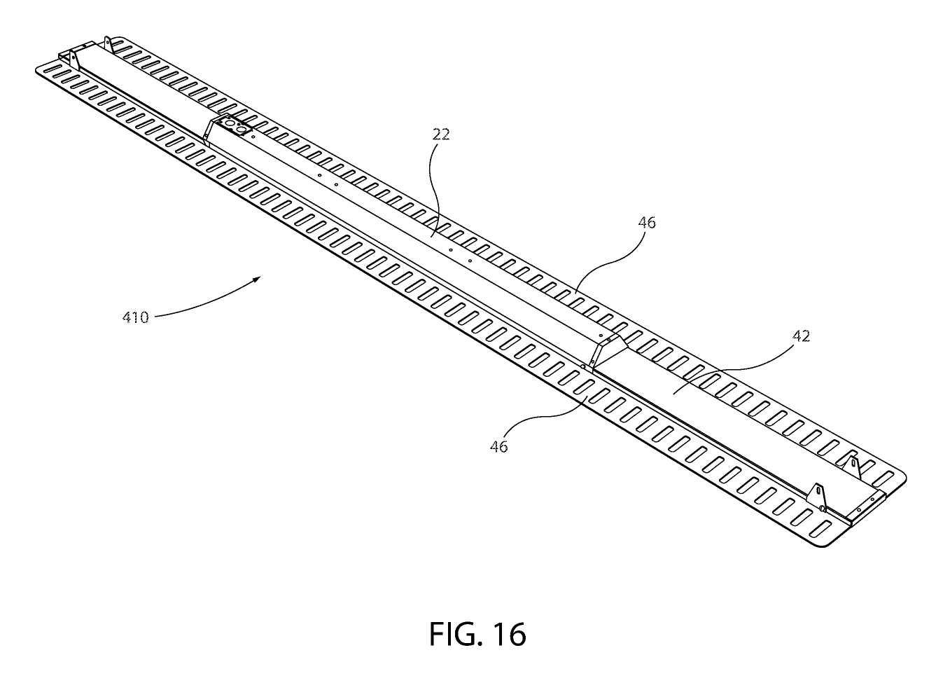

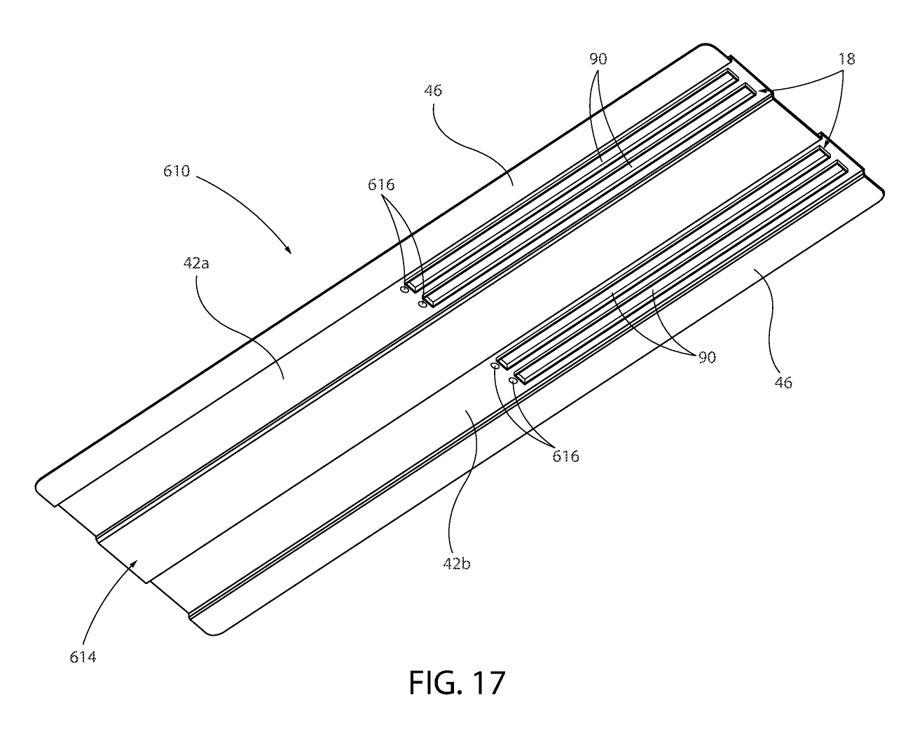

In yet another embodiment, shown in FIGS. 15 and 16, the luminaire 410 may have a longer length such that the light emitter component 18 includes more than two sets of LED board pairs. In the illustrated embodiment, the LED boards are covered by refractors 118 (FIG. 15); in other embodiments, the LED boards may be covered by a diffuser 98 supported in the channel 42. Although two sets of LED board pairs are shown, the luminaire 410 of FIG. 15 can support up to four pairs. In other embodiments, the luminaire 410 may support fewer or more sets of LED board pairs. In some embodiments, the luminaire 10 has a length measured along the axis 38 of approximately four feet, and each refractor 118 has a length of approximately two feet such that two pairs of refractors 118 extend along the length of the luminaire 10. In some embodiments, the luminaire 410 has a length of approximately eight feet such that four pairs of refractors 118 extend along the luminaire 410.

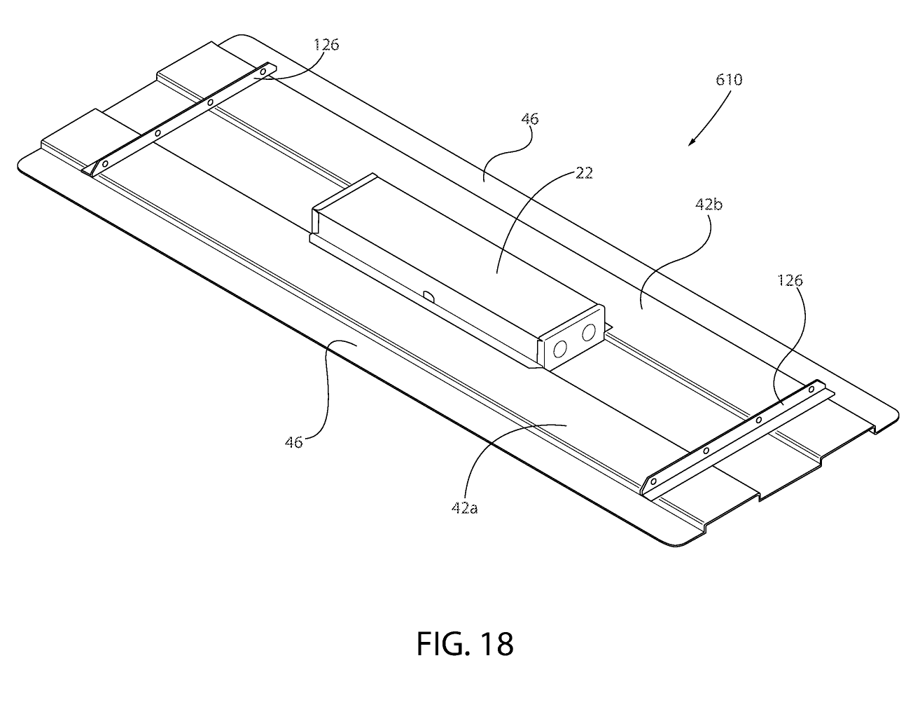

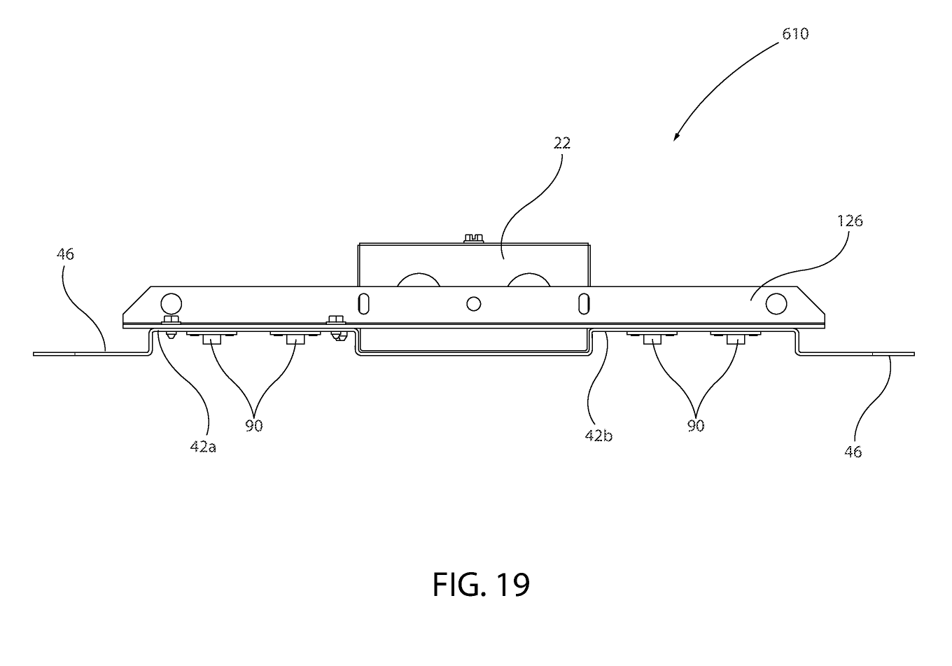

FIGS. 17-19 illustrate another embodiment of the luminaire 610 in which the support member 614 is formed with two channels 42a, 42b positioned parallel to one another. In this embodiment, each channel 42a, 42b supports two sets of LED board pairs aligned end to end (only one pair is shown in each channel 42a, 42b in FIG. 17). In addition, openings 616 are formed between the adjacent pairs of refractors 118, and wires (not shown) pass through the openings 616 to provide communication between the enclosure 622 and the LED boards. The luminaire 610 may have a similar length to the luminaire 10 of FIGS. 1-6, but may have an increased width to accommodate the additional channel 42b and rows of LED boards 90. The LED boards 90 may be covered by refractors 118 and/or each channel 42a, 42b may support a diffuser 98. The enclosure 22 (FIGS. 18 and 19) is coupled to the support member 14 between the channels 42a, 42b. In addition, braces 126 (FIGS. 18 and 19) extend between and are coupled to the channels 42a, 42b to provide additional rigidity. The braces 126 may include additional holes/slots to accommodate various options for suspending and supporting the luminaire 610.

The luminaires 10, 410, 610 are lightweight and have a slim profile providing a “floating plate” appearance. The wiring terminations of the light emitting elements are positioned toward the interior of the luminaire rather than at the ends 30, 34, thereby permitting the wires to pass through the support member 14 and allowing a short enclosure 22 for housing the wiring and control assembly. The short length and the inclined longitudinal surfaces 66 of the enclosure 22 allow the enclosure 22 to remain behind the support member 14 and out of sight at most viewing angles.

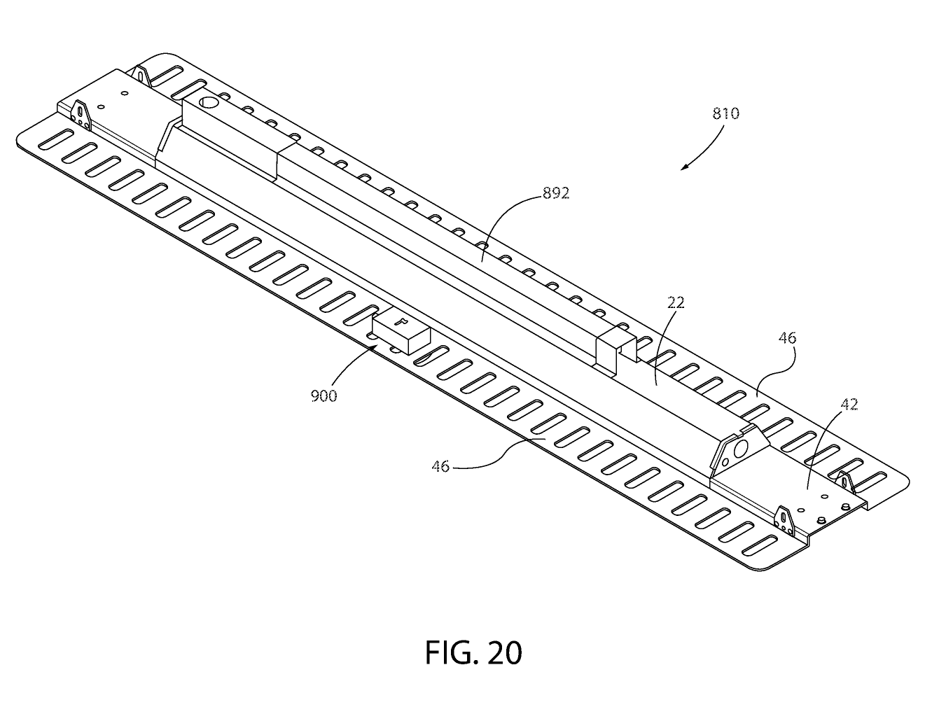

FIGS. 20-22 illustrate another embodiment of the luminaire 810. The luminaire 810 is similar to the luminaire 10 described above with respect to FIGS. 7-12, and similar features are identified with similar reference numbers, plus 800. As shown in FIG. 20, the luminaire 810 includes a battery 892 positioned on an upper surface of the luminaire 810. In the illustrated embodiment, the battery 892 is positioned on an upper surface of an enclosure 22 and is secured by a pair of supports 896 (e.g., brackets formed from sheet metal). In some embodiments, the battery 892 is an LED emergency driver and includes a housing having a narrow profile.

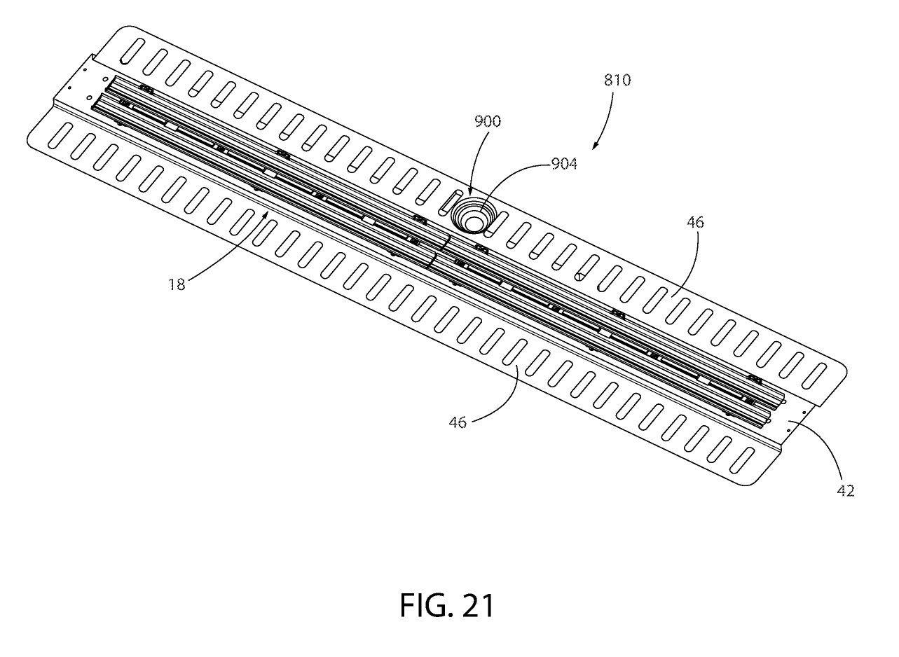

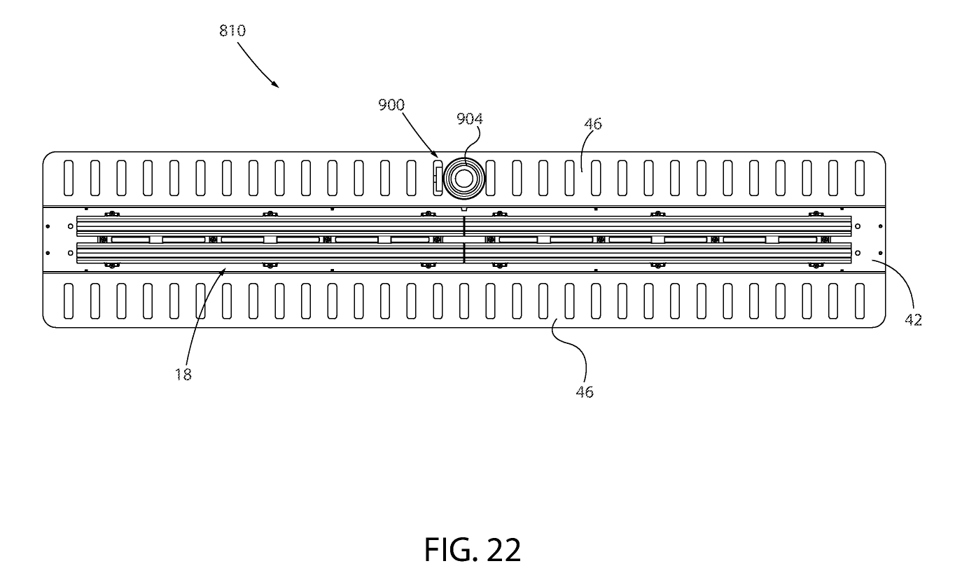

Referring to FIGS. 21 and 22, the luminaire 810 further includes an occupancy sensor 900. In the illustrated embodiment, the sensor 900 is coupled to a side flange 46 and includes a round lens 904 positioned on a lower surface of the flange 46. The lens 904 faces away from the luminaire 810. Low voltage wires (not shown) may pass into the enclosure 22 (FIG. 20) through one of the side surfaces of the enclosure 22. In some embodiments, the sensor 900 is a passive infrared (PIR) sensor that detects occupancy within a predetermined area. When occupancy is detected, the sensor 900 transmits a signal to turn on the light element 18. When occupancy is no longer detected after a predetermined period of time, the light element 18 is turned off.

Although certain embodiments have been described in detail, variations and modifications exist within the scope and spirit of one or more independent aspects as described.

1. A luminaire comprising:
a support member including a first end and a second end and defining a longitudinal axis extending therebetween, the support member defining a center portion extending along the longitudinal axis and a pair of flanges, each flange formed on one side of the center portion and extending along the center portion in a direction parallel to the longitudinal axis, the flanges and the center portion being substantially coplanar; and
a light assembly including at least one board supporting at least one light emitting element, the board coupled to the center portion of the support member and oriented parallel to the longitudinal axis.

2. The luminaire of claim 1, wherein the flanges are coplanar with one another.

3. (canceled)

4. The luminaire of claim 1, wherein the center portion is defined by a channel formed in a flat plate.

5. The luminaire of claim 1, wherein the channel is formed by a jog bend formed between the center portion and each flange, wherein each jog bend includes a pair of alternating bends offset by an offset distance.

6. The luminaire of claim 4, wherein the channel has a height that is between about 3.7% and about 5% of a width of the support member.

7. (canceled)

8. The luminaire of claim 4, wherein the channel has a height that is between about 9.3% and about 13.8% of a width of the channel.

9. The luminaire of claim 8, wherein the channel has a height that is about 11.5% of a width of the channel.

10. The luminaire of claim 1, further comprising an enclosure coupled to a surface of the support member opposite the surface to which the light assembly is coupled, the enclosure housing a control assembly for the light assembly, the control assembly in communication with the light assembly through at least one opening in the support member.

11. The luminaire of claim 10, wherein the enclosure is aligned along the longitudinal axis and includes at least one inclined surface extending parallel to the longitudinal axis, each inclined surface forming an acute angle relative to the center portion of the support member.

12. (canceled)

13. The luminaire of claim 1, wherein the at least one light board includes at least one pair of LED boards positioned parallel to one another and parallel to the longitudinal axis.

14. The luminaire of claim 13, wherein the at least one light board includes at least two pairs of LED boards, each pair is arranged end-to-end with respect to the other pair.

15. The luminaire of claim 1, wherein the light assembly includes at least one refractor coupled to the support member and covering the length of at least one light board.

16. The luminaire of claim 15, wherein the refractor is an aisle refractor directing light from the at least one light emitting element along a generally linear path.

17. The luminaire of claim 1, wherein the light assembly includes a diffuser coupled to the support member and covering the length of the at least one light board.

18. The luminaire of claim 17, wherein the diffuser includes a pair of ends, each end positioned between at least one screw and a surface of the center portion to retain the diffuser relative to the support member.

19. The luminaire of claim 1, wherein the center portion is formed by a pair of parallel channels extending parallel to the longitudinal axis, wherein the light assembly includes at least one light board coupled to a surface of the support member and positioned in each channel.

20. The luminaire of claim 19, further comprising an enclosure positioned between the parallel channels, the enclosure coupled to a surface of the support member opposite the surface to which the light assembly is coupled.

21. The luminaire of claim 19, further comprising at least one brace extending between the parallel channels, the brace coupled to both channels.

22. The luminaire of claim 1, further comprising an occupancy sensor secured to one of the flanges.

23. A luminaire comprising:
a support member including a first end and a second end and defining a longitudinal axis extending therebetween, the support member further including a channel and at least one flange coupled to the channel, the channel and the at least one flange extending along the longitudinal axis; and
a light assembly including at least one circuit board supporting at least one light emitting diode, the at least one light board being coupled to one surface of the support member and positioned within the channel, the light board oriented parallel to the longitudinal axis.

24. The luminaire of claim 23, wherein the luminaire includes a pair of flanges that are parallel to one another, the channel positioned between the flanges.

25. (canceled)

26. The luminaire of claim 23, wherein the channel is formed by a jog bend formed between the center portion and each flange, wherein each jog bend includes a pair of alternating bends offset by an offset distance.

27. The luminaire of claim 23, further comprising an enclosure coupled to a surface of the support member opposite the surface to which the light assembly is coupled, wherein the enclosure houses a control assembly for the light assembly, wherein the light assembly is in communication with the control assembly through a hole in the channel.

28. (canceled)

29. The luminaire of claim 23, wherein the at least one circuit board includes at least one pair of LED boards positioned parallel to one another and parallel to the longitudinal axis.

30. The luminaire of claim 29, wherein the at least one circuit board includes at least two pairs of LED boards, each pair is arranged end-to-end with respect to the other pair.

31. The luminaire of claim 23, further comprising at least one refractor coupled to the support member and covering the length of at least one circuit board, wherein the refractor is an aisle refractor directing light from the at least one light emitter along a generally linear path.

32.-34. (canceled)

35. The luminaire of claim 23, wherein the center portion is formed by a pair of parallel channels extending parallel to the longitudinal axis, wherein the light assembly includes at least one light board coupled to a surface of the support member and positioned in each channel.

36. The luminaire of claim 35, further comprising an enclosure positioned between the parallel channels, the enclosure coupled to a surface of the support member opposite the surface to which the light assembly is coupled.

37.-45. (canceled)
